(19) United States
(12) Patent Application Publication
(10) Pub. No.: US 2014/0183964 A1
(43) Pub. Date: Jul. 3, 2014

(54) Power Transmitting Device Having Power Theft Detection and Prevention

(71) Applicant: BROADCOM CORPORATION, Irvine, CA (US)

(72) Inventor: John WALLEY, Ladera Ranch, CA (US)

(73) Assignee: Broadcom Corporation, Irvine, CA (US)

(21) Appl. No.: 13/857,457

(22) Filed: Apr. 5, 2013

Related U.S. Application Data
(60) Provisional application No. 61/747,061, filed on Dec. 28, 2012.

(51) Int. Cl. H04B 5/00

(52) U.S. Cl. CPC H04B 5/0037
USPC 307/104

(57) ABSTRACT

A wireless power transfer system is disclosed that includes multiple levels of authentication and several different options for implementing theft prevention. The power station can perform a first authentication procedure to collect billing information of the device to receive power. If the first authentication succeeds, the power station then performs a second authentication procedure in which it sends one or more test power signals to the receiving device. The power station estimates the amount of power that should actually be received by the receiving device and compares the estimate to a reported value sent from the receiving device to ensure that the reported value is within an acceptable margin of the estimate value. If either authentication fails, the power station can take power theft prevention methods to prevent the receiving device from acquiring free power.

### CROSS REFERENCE TO RELATED APPLICATIONS

This application claims the benefit of U.S. Provisional Patent Application No. 61/747,061, filed on Dec. 28, 2012, which is incorporated by reference herein in its entirety.

### BACKGROUND

1. Field of Invention

The disclosure relates to a wireless charging station and wirelessly-chargeable receiver and specifically to the protection against power theft and foreign object detection in a wireless power transfer environment.

2. Related Art

Wireless power transfer stations, such as power pads, have recently become known. However, conventional wireless power transfer stations provide power indiscriminately to any capable device in its vicinity. Therefore, an unauthorized device can easily obtain power from conventional wireless power transfer stations.

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates an exemplary wireless power transfer environment;

FIG. 2 illustrates a block diagram of an exemplary wireless power transfer station;

FIG. 3 illustrates a block diagram of an exemplary power station that is capable of preventing power skimming;

FIG. 4 illustrates a plan view of an exemplary power station for using temperature sensing to detect foreign objects;

FIG. 5 illustrates a top-down plan view of an exemplary power station for detecting foreign objects;

FIG. 6 illustrates a block diagram of an exemplary method for transferring power from a power station to a chargeable receiving device; and

FIG. 7 illustrates a block diagram of an exemplary general purpose computer system.

### DETAILED DESCRIPTION OF THE INVENTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer, as described below.

For purposes of this discussion, the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Those skilled in the relevant art(s) will recognize that this description may be applicable to many various charging and/or communication methods without departing from the spirit and scope of the present disclosure.

An Exemplary Wireless Power Transfer Environment

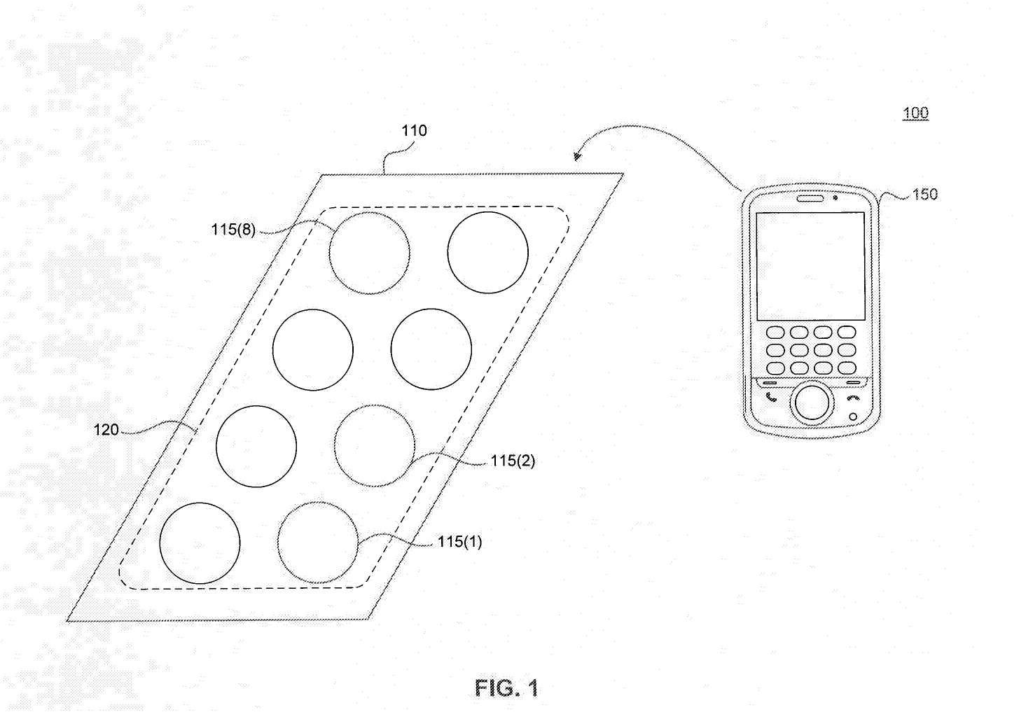

FIG. 1 illustrates an exemplary wireless power transfer environment 100. The environment 100 includes a wireless power transfer station (hereinafter “power station”) 110. The power station 110 includes at least one coil 115 (115(1)-115(8) in the example of FIG. 1) arranged in a grid or matrix pattern. The coils send and receive signals between a wirelessly-chargeable device 150. The exchanged signals can include data, commands and/or other communications, and can be used to transfer power from the power station 110 to the device 150. In an embodiment, the coils 115 of the power station 110 may be used as secondary coils to a primary coil 120, discussed in detail below.

When a user of the device 150 seeks to wirelessly charge a battery or other power storage device within the device 150, the user moves the device 150 to be within a proximity of the power station 110. After an initialization and setup period, the power station 110 loads power transfer signals onto one or more of its coils 115 and transmits those signals to the device 150. The device receives the signals from the coils 115 of the power station 110 and extracts power therefrom. In this manner, the power station 110 functions as a power transmitter and the device 150 functions as a power receiver. In embodiments, the wireless power transfer is implemented as a magnetic coil-to-coil power transfer using a transmit coil and a receive coil. The transmit coil is excited with an AC current to produce an alternating magnetic field, that induces a secondary AC current in the receive coil. The secondary current can then be rectified using a diode bridge so as to produce a DC voltage that can be stored in a battery or used to power receiver circuits.

Exemplary Wireless Power Transfer Device and Functionality

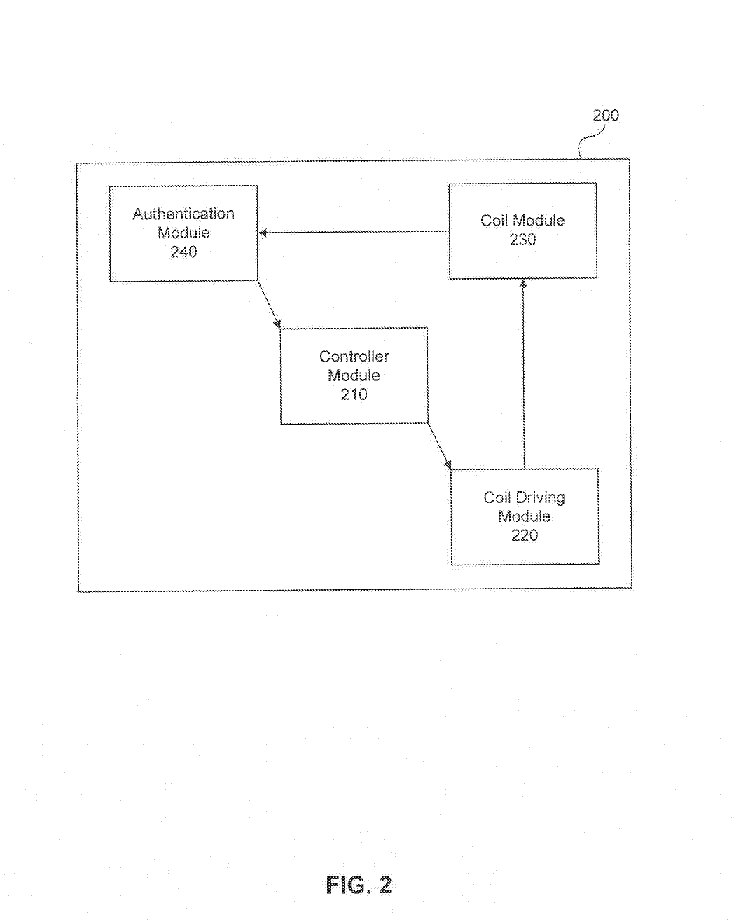

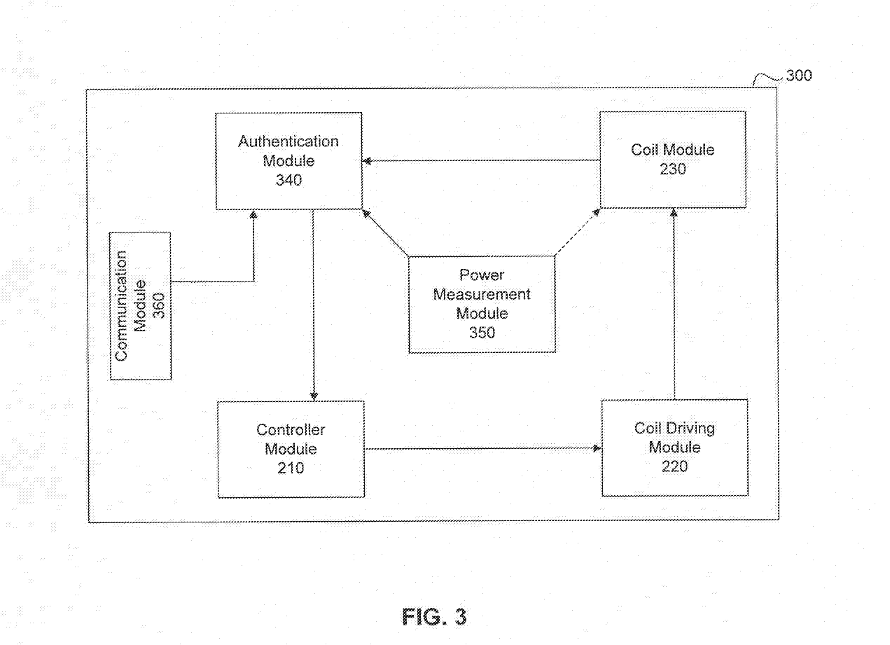

FIG. 2 illustrates a block diagram of an exemplary wireless power transfer station 200. The power station 200 includes a controller module 210, a coil driving module 220, a coil module 230, and an authorization module 240, and may represent an exemplary embodiment of the power station 110. It should be understood that the following descriptions of the structure, functions, and capabilities of the power station 200 described in FIG. 2, as well as with respect to the additional devices illustrated in FIGS. 3-5 can be similarly applied in a multi-standard system and may employ out-of-band communications for carrying out communications operations.

The coil module 230 may include one or more power transfer coils that are capable of being loaded with power transfer or other communication signals, and which are capable of receiving signals via load modulation or other communication standard. The coil driving module 220 drives one or more of the coils based on instructions received from the controller module 210.

When the power station 200 detects the presence of a chargeable device in its vicinity, the controller module 210 begins an initiation phase of power transmission. During the initiation phase, the controller module 210 causes the coil driving module 220 to drive the coil module 230 to transmit a small amount of power to the receiving device. This small amount of power should be limited to an amount sufficient to allow the receiving device to negotiate with the power station 200. Ideally, the initiation power would be impractical for charging purposes. In this manner, an unauthorized device could not charge from the initiation charge. Alternatively, the initiation power can be sufficient for charging purposes, but only supplied for a limited amount of time. This amount of time is preferably only slightly longer than an expected authentication period. At the end of the initiation period, if the receiving device has not been authenticated, the supply of wireless power to the receiving device can be halted.

During the initiation phase, the power station 200 exchanges information and/or instructions with the receiving device in order to acquire authentication information from the receiving device. In an embodiment, the authentication information includes identification and/or password or other access key information. In an embodiment, the authentication information includes billing information, such as bank account, credit card, or other electronic funds transfer information. As shown, for example, in FIGS. 2 and 3, the authentication information can be received by the coil module 230/330 using in-band communication protocols, and/or from the communication module 360 using out-of-band communications.

The coil module 230 forwards the received authentication information to an authentication module 240. The authentication module 240 carries out an authentication procedure, using the received authentication information. The authentication process results in allowing or restricting access to the nearby receiving device based on whether the authentication process succeeded or failed.

Allowing and Restricting Access to Power

If the authentication module 240 determines that the authentication process has succeeded, the authentication module 240 transmits an authentication success signal to the controller module 210. The controller module 210 then instructs the coil driving module 220 to drive the one or more coils that correspond to the receiving device to transmit a charging power to the device. The charging power may be larger than the initiation power level and/or have a longer supply duration, and should be sufficient for the receiving device to charge its battery.

If, on the other hand, the authentication module 240 determines that the authentication process has failed, the authentication module 240 transmits an authentication failed signal to the controller module 210. The power station 200 can then institute one or more of several possible theft prevention methods.

In an embodiment, upon a failed identification, the coil driving module 220 can decommission power to the one or more coils 115 corresponding to the receiving device 150. These coils can be identified by the coil driving module 220 based on loads and other signals of those coils 115. Once identified, the coil driving module 220 can then stop the supply of power signals to those coils 115.

In an embodiment, the coil module 220 can shift a transmission frequency and/or phase of the transmitted power signals. For example, in an environment where the power station 200 is capable of charging multiple devices at a given time, the power station 200 can privately set unique phase and/or frequencies for the power transmission signals. The authentication information can be obtained using a standard phase and/or frequency. Once authenticated, private phase and/or frequency information can be transmitted to the authenticated receiving devices. In this manner, each authenticated device will have a private power transmission channel on which to receive power from the power station 200.

Similarly, rather than transmitting a private single frequency to be used in communication, the power station 200 can provide a frequency hopping code to be used in a frequency-hopping algorithm. The power station 200 and the receiving device can then transfer power over a frequency-hopping algorithm defined by the private code or other notifier. With different coils, different frequency-hopping or other algorithms may be run on each to provide different power/power levels to different devices.

When a device fails the authentication process, the coil driving module 220 can cause the coils 115 of the coil module 230 to shift frequency and/or phase without informing the receiving device 150 as to the new transmission information. In this manner, the unauthorized receiving device 150 will be unable to receive the signals being transmitted from the coil module 230.

In an embodiment, when the controller module 210 receives the authentication failed signal from the authentication module 240, the controller module 210 can instruct the coil driving module 220 to stop all power transmission. This halt may last for a predetermined time, until a new receiving device is detected, until the power station 200 detects the absence of the unauthorized receiving device, or until the occurrence of another trigger within the spirit and scope of the present disclosure.

In an embodiment, the coil driving module can simply continue transmitting at the low initiation power. As discussed above, this initiation power should be insufficient for practical charging purposes. Therefore, simply maintaining the initiation power may be a sufficient deterrent in some scenarios.

In another embodiment, the power station 200 includes a plurality of coils in its coil module 230. Upon detecting the presence of an unauthorized device, the power station 200 can next determine a location of the unauthorized device. For example, by monitoring load impedance incident of the various coils of the coil module 230, the power station 200 can determine a relatively accurate position of the unauthorized device with respect to the various coils. Once this position has been determined, the controller module 210 can cause the coil driving module 220 to drive two or more of the various coils at calculated frequencies to cause spatial anti-phase mixing at the location of the unauthorized device. By controlling the frequencies of these coils, the power station 200 is able to cancel the magnetic field at the location of the unauthorized device.

Alternatively, or in addition, to any of the above power theft prevention techniques, alarms can be used to notify relevant persons or monitoring system of the unauthorized device. For example, upon determining that the device is unauthorized, the power station 200 may generate an audible or visual alarm to notify a user or station manager of the unauthorized charging attempt. Similarly, the alarm may be transmitted via network/cloud to a remote location or monitoring authority. For example, local security may be informed of the attempted breach in order to respond and remedy the unauthorized attempt.

Preventing Power Skimming

After a device has been authenticated and given access to receiving power, there may be other ways for the receiving device to steal power from the power station. For example, in wireless transfer protocols, the amount of power loaded onto the coils of the power station if often different from the amount of power received by the receiving device. This differential can be explained by the efficiency of the system, which often is not perfect.

In an embodiment, the amount of money charged for the power transferred to the receiving device is a function of the amount of power actually received by the receiving device. Therefore, it may be necessary to communicate with the receiving device in order to obtain a report of the amount of power actually received. However, if the receiving device falsifies or erroneously generates this report (e.g., reports an amount received that is lower than actual), the receiving device is able to acquire more power than that for which the user of the receiving device actually pays (“power skimming”).

FIG. 3 illustrates an exemplary power station 300 that is capable of preventing power skimming. The power station 300 includes a power measurement module 350 and a communication module 360, and may represent an exemplary embodiment of the power station 110.

In the power station 300, the power being transmitted from the coil module 230 is measured by a power measurement module 350. The power measurement module 350 forwards the measured amount of power to the authentication module 340 for analysis.

The authentication module 340 can be programmed with a transfer function. The transfer function is a function for estimating an amount of power that should be received by the receiving device based on the amount of power loaded onto the coil module 230. Therefore, using the received measured power value from the power measurement module 350, the authentication module 340 can estimate the amount of power being received by the receiving device.

In addition, the controller module 210 can control one or more of the coil module 230 and the communication module 360 to acquire a received power report from the receiving device. For example, the power station 300 can receive the received power report via load modulation of one or more of the coils within the coil module 230 or via any available wired or wireless communication method via the communication module 360, including NFC, Bluetooth, Wi-Fi, etc.

Once the authentication module 340 obtains the received power report from the receiving device, the authentication module 340 compares the amount of power reported by the receiving device to the estimated amount of power. Based on the comparison, the authentication module 340 then makes a determination as to whether the device remains authenticated for receiving power.

For example, if the amount of power reported by the receiving device is greater than the estimated amount of power, the authentication module 340 determines that the receiving device is still authenticated, and takes no further action. If the reported amount of power is less than the estimate, the authentication module 340 compares the reported amount of a threshold value. The threshold value may be set as a percentage of the estimated value, for example. If the reported amount is above the threshold value, the authentication module 340 assumes the report is accurate and allows for the power transfer to continue.

If, on the other hand, the reported value is less than the threshold value, the authentication module 340 assumes that the report is false or at least erroneous and notifies the controller module 210 that the receiving device is no longer authenticated for power transfer. Consequently, the controller module 210 controls the coil driving module 220 to halt or reduce power transfer to the receiving device. In this manner, the power station 300 is able to prevent power skimming by the receiving device.

Power skimming can also be prevented at the outset of power transfer. For example, during the initial authentication process between the power station 300 and the receiving device 150, the power station 300 can perform a power reporting authentication routine. As a part of this routine, the coil driving module 220 can drive the coil module 230 with several different power levels at different time intervals, and the communication module 360 can obtain received power reports from the receiving device after each interval. This allows the authentication module 340 to compare data for multiple different power levels in order to increase comparison accuracies, or to determine at the outset as to whether the receiving device is accurately reporting received power.

In addition to transmitting at different power levels, the power station 300 can also instruct the receiving device via the communication module 360 and/or coil module 230 to employ different load for one or more of the transmitted test power signals. This change in load can be detected by the coil module 230 of the power station 300 in order to determine if the receiving device is complying with instructions. In addition, load data provides the authentication module 340 with an additional layer of data for use in its accuracy determinations. Using one or more of these procedures can even further improve protection against power skimming.

Power skimming can also be prevented that would otherwise occur towards the end of power exchange. For example, in an embodiment, a device may be authenticated and billed for a predetermined amount of power/time. However, the receiving device may seek to extend its charging beyond those valued. Therefore, in an embodiment, reauthorization can be required after predetermined intervals or intervals set by earlier payment in order to prevent post-skimming of power.

Foreign Object Detection

Foreign objects in the vicinity of the power station can absorb power transmitted to the environment. This can greatly reduce efficiency of power transfer. In addition, foreign objects may heat up from the absorbed energy, which can be a safety hazard. Therefore, power stations should implement some form of foreign object detection in order to improve safety and to improve efficiency and authentication of power transfers.

Conventionally, a power transmitter detects foreign objects by estimating an amount of power consumed by foreign objects, and comparing that amount to a threshold. Although this method may be effective for identifying foreign objects in some instances, the accuracy of the method is low, and therefore many foreign objects are often overlooked.

In an embodiment, one option is increase the frequency at which the power signals are transmitted. For example, the coil driving module 220 can drive the coil module 230 at a high frequency. Eddy currents decrease at higher frequencies. Therefore, by increasing the transmission frequency of the power signals, the power station 300 can naturally reduce the effects of foreign objects.

In an embodiment, the power station can utilize the receiving device to assist in the foreign object detection. For example, for a receiving device that has been authenticated, the power station can request received power statistics from the receiving device. Based on the known amount of power transmitted, and the reported amount of power received by the receiving device, the power station 300 can determine if foreign objects are present. For example, if the reported amount of received power is significantly lower than the amount of transmitted power, this would suggest that a foreign object is absorbing some of the transferred power.

In an embodiment, the power station can detect foreign objects using sideband sensing. For example, such sideband sensing may include infrared sensing or temperature sensing to detect hot areas of the power station, which may be indicative of a foreign object. When infrared is used, the measured heat data will be compared to some baseline value in order to determine whether there are any hot spots on the power station.

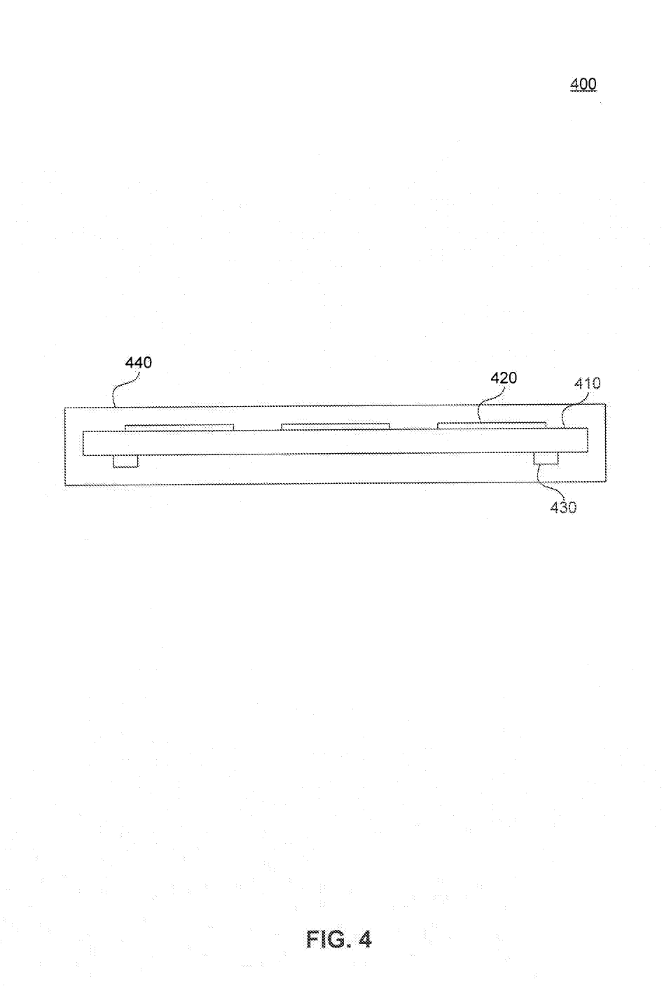

FIG. 4 illustrates a plan view of an exemplary power station 400 for using temperature sensing to detect foreign objects. The power station 400 includes a plurality of coils 420 disposed on a ferrite material plate 410. A plurality of temperature sensors are attached to the ferrite material 410.

As the foreign objects absorb transmitted power, they will heat up, causing a temperature of the ferrite plate 410 to heat up in localized areas. The temperature sensors 430 detect the temperature of the ferrite plate 410 at these localized areas to determine whether a foreign object is present. In an embodiment, the temperature sensors 430 are disposed on a housing 440 that encases the ferrite plate 410. In this configuration, the temperature sensors 430 detect the internal temperature of the power station 400 rather than the direct temperature of the ferrite material 410.

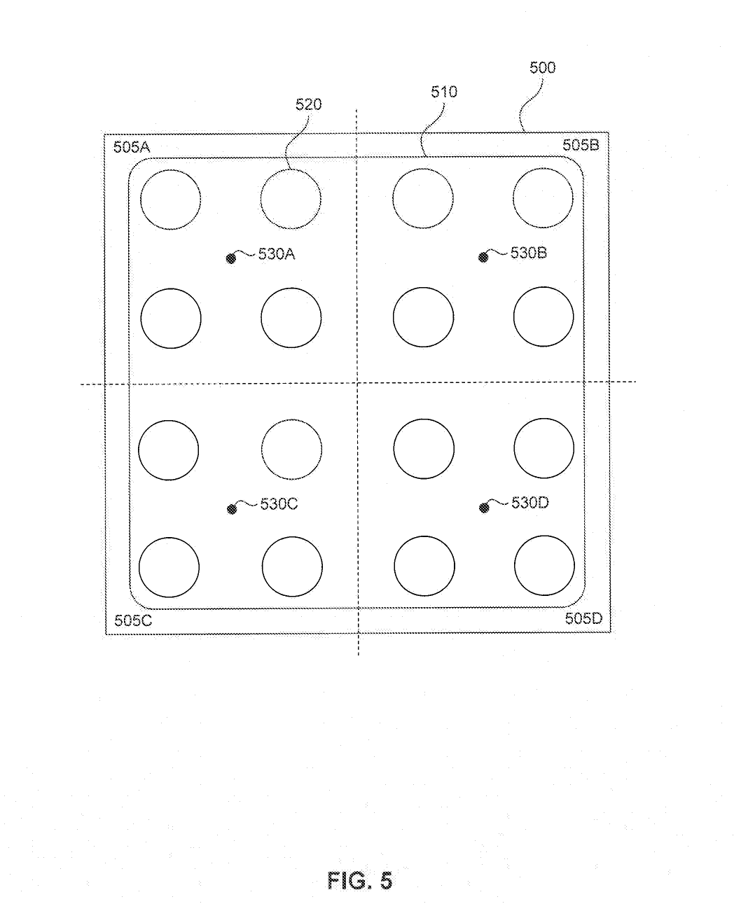

FIG. 5 illustrates a top-down plan view of an exemplary power station 500 for detecting foreign objects. The power station 500 includes a ferrite plate 505 and a plurality of temperature sensors 530. The power station 500 further includes a primary coil 510 and a plurality of secondary coils 520, and may represent an exemplary embodiment of the power station 110.

The power station 500 demonstrates multiple foreign object detection configurations that may or may not be used together. In an embodiment, the ferrite plate 505 is broken into multiple sections 505A-505D. A temperature sensor 530A-530D is provided to each of these sections, respectively, for detecting localized temperature changes in the ferrite material.

In another embodiment, the temperature of the ferrite sections 505A-505D can be determined by measuring the resistance changes of each of the those section. As the ferrite material 505 heats up, its resistance will change. By measuring a current passed through each corresponding ferrite material section 505A-505D, temperature changes of those sections can be determined.

In an embodiment, the coils 520/510 can be used to determine whether foreign objects are in the vicinity. The coils cover a large surface area of the power station 500. Further, the coils 510/520 are metallic and can be constructed with materials that are good heat conductors. Similar to the ferrite material, when the metal of the coils 510/520 heats up, their resistances will change. By passing a known current through the coils 510/520 and measuring the voltage change, heat changes can be detected.

The foreign object detection can be performed without interrupting power transfer to another device. For example, the primary coil 510 can be used to transmit power signals to a receiving device while the power station 500 measures voltage changes in each of the secondary coils 520. Alternatively, the power station 500 can transmit power to a receiving device via one or more of the secondary coils 520, while measuring voltage changes among the remaining secondary coils 520.

The power station 500 can temporarily energize the secondary coils to perform foreign object detection. Once the foreign object detection procedure has completed, the power station 500 can de-energize those same coils in order to save power. Further, in order to avoid interfering with the coils being used to charge the receiving device, the unused coils can be energized at a different frequency from the charging coils.

Additional configurations may be available to detect the presence of foreign objects, such as for example video/still camera detection, laser scanning and pressure sensing, among others within the spirit and scope of the present disclosure. Using any of the above foreign object detection methods will allow for efficient power transfer and accurate authentication with a receiving device.

In an embodiment, the power station 500 is capable of detecting and distinguishing between a foreign object and an unauthorized device. In doing so, the power station 500 measures power and/or impedances across multiple of its coils 520 and/or at multiple frequencies. By analyzing the results of these measurements, the power station 500 can characterize the object as an unauthorized device or foreign object. The power station 500 can then take different actions depending on its determination. For example, if the power station 500 determines that a foreign object is present, the power station 500 can stop any or nearby charging operations as a safety precaution. Alternatively, if the power station 500 determines that an unauthorized phone is present, the power station 500 may implement any of the power control methods described above.

Exemplary Method for Wirelessly Transmitting Power

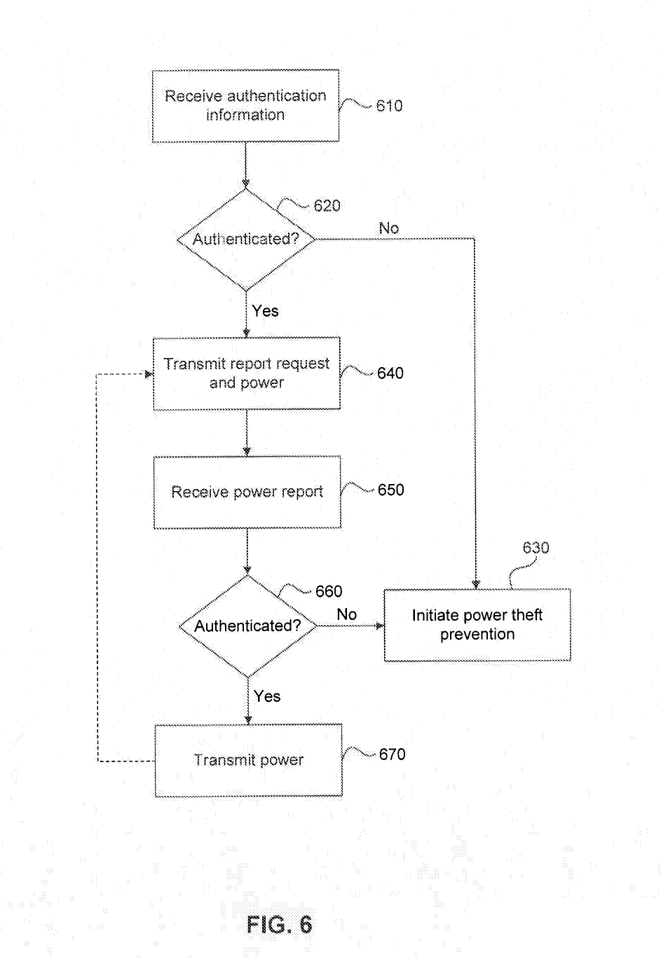

FIG. 6 illustrates a block diagram of an exemplary method for transferring power from a power station to a chargeable receiving device.

Initially, the power station receives authentication information from the receiving device (610). This information can be received via load modulation over the WPT standard, or using any other available communication standard, including NFC, WiFi, Bluetooth, etc. Based on the received authentication information, the power station determines whether the receiving device is authenticated for power transfer (620).

If the power station determines that the receiving device is not authenticated (620—N), the power station initiates a power theft prevention measure (630). This measure may include decommissioning power to coils corresponding to the receiving device, shifting frequencies of those coils, or shutting down the transmission, among others.

If, on the other hand, the power station determines that the receiving device is authenticated (620—Y), the power station transmits a report request as well as test power signals (640). The test power signals may be chosen at different power level, different frequencies, and for different loads. In response to the report request, the power station receives a received power report from the receiving device (650) that reports the amount of power actually received for the different test power signals.

Based on the report, the power station determines whether the receiving device is authenticated (660). This second authentication may be performed by comparing the reported power levels to expected/estimated power levels. If the reported levels are too low compared to the estimated levels, then the power station determines that the receiving device failed the power report authentication (660—N). When this occurs, the power station implements one or more of the power theft prevention measures detailed above (630).

If, on the other hand, the power station determines that the reported power values are sufficient close to the estimated values, then the power station authenticates the receiving device (660—Y). Once the receiving device has successfully passed the second authentication (660—Y), the power station begins transmitting power (670).

During power transmission (670), the power station can periodically request an updated received power report from the receiving device (640) in order to verify that proper tracking is being performed. When this occurs, the power station proceeds back through steps 650 and 660 before returning to power transmission (670).

Those skilled in the relevant art(s) will recognize that the above method can additionally or alternatively include any of the functionality of the power station 110 discussed above, as well as any of its modifications. Further, the above description of the exemplary method should neither be construed to limit the method nor the description of the mobile device power station 110.

Exemplary Computer System Implementation

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

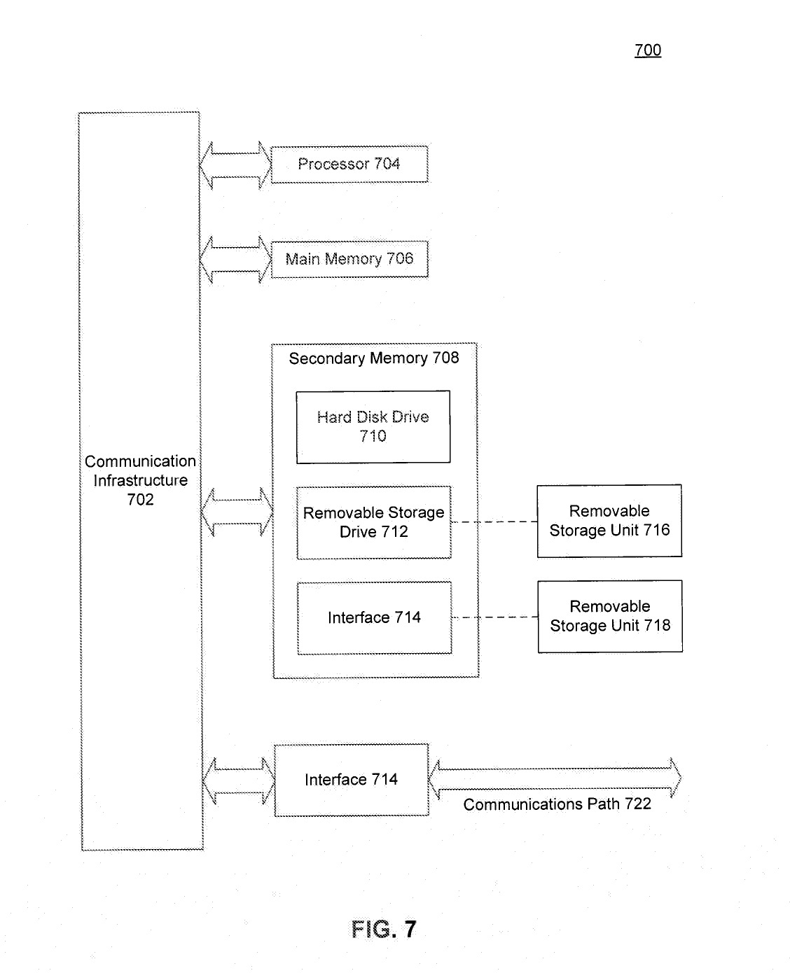

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 700 is shown in FIG. 7. One or more of the modules depicted in the previous figures can be at least partially implemented on one or more distinct computer systems 700.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the invention should not be limited by any of the above-described exemplary embodiments, but should be defined only in accordance with the following claims and their equivalents.

What is claimed is:

1. A device capable of transmitting wireless power to a receiving device in a wireless power transfer environment, the device comprising:
a coil module configured to transmit a test power signal;
a communication module configured to transmit a report request to the receiving device, and to acquire a received power report from the receiving device that indicates an amount of power received based on the test power signal;
an authentication module configured to estimate an amount of power received by the receiving device based on parameters of the test power signal, and to compare the reported amount of power received to the estimated amount of power; and
a controller module configured to permit or prohibit power transfer to the receiving device based on the comparison of the reported amount of power to the estimated amount of power.

2. The device of claim 1, wherein the coil module is configured to transmit a plurality of different test power signals, and
wherein the authentication module estimates an amount of power received for each of the plurality of test power signals, and compares the estimated values to corresponding reported values included within the received power report.

3. The device of claim 2, wherein the plurality of test power signals differ by at least one of amplitude, frequency, and duration.

4. The device of claim 1, wherein the authentication module authorizes the receiving device when the reported amount of power is within a threshold value of the estimated amount of power.

5. The device of claim 1, wherein the communication module is configured to transmit a load instruction to the receiving device that includes a load to be implemented during receipt of the test power signal, and
wherein the coil module is configured to detect whether the received device has implemented the load.

6. The device of claim 5, wherein upon detecting that the receiving device has failed to implement the load, the controller module is configured to prohibit power transfer to the receiving device.

7. The device of claim 1, further comprising a foreign object detector configured to detect a presence and a location of a foreign object within the vicinity of the device.

8. A device capable of transmitting wireless power to a receiving device in a wireless power transfer environment, the device comprising:
a coil module configured to receive first authentication information from the receiving device;
a communication module configured to receive second authentication information from the receiving device different from the first authentication information;
an authentication module configured to perform a first authentication procedure based on the first authentication information and configured to perform a second authorization procedure based on the second authentication information, the second authentication procedure being different from the first authentication procedure; and
a controller module configured to allow power transfer to the receiving device only after both the first authentication procedure and the second authentication procedure have been passed.

9. The device of claim 8, wherein the coil module transmits a small amount of power to the receiving device during each of the first authentication procedure and the second authentication procedure.

10. The device of claim 9, wherein the coil module is configured to transmit a large amount of power to the receiving device only after the receiving device has passed both the first authentication procedure and the second authentication procedure.

11. The device of claim 8, wherein the authentication module performs the second authentication procedure only after the first authentication procedure has been passed.

12. The device of claim 8, wherein the first authentication information includes billing information.

13. The device of claim 8, wherein the second authentication information includes an amount of power received based on a test power signal.

14. The device of claim 13, wherein the second authentication procedure includes comparing the amount of power received to an estimated amount of power received.

15. A method of wirelessly transmitting power by a power station to a receiving device, the method comprising:
receiving first authentication information from the receiving device;
performing a first authentication procedure based on the first authentication information; and
if the first authentication fails, implementing a power theft prevention measure.

16. The method of claim 15, wherein the power theft prevention measure includes at least one of de-energizing one or more coils associated with the receiving device, changing a frequency of a power transmission signal, and shutting down a transmitter of the power station.

17. The method of claim 15, further comprising, if the first authentication succeeds:
transmitting an instruction signal to the receiving device;
transmitting a test power signal to the receiving device; and
receiving second authentication information from the receiving device based on the instruction signal and the test power signal.

18. The method of claim 17, further comprising, if the first authentication succeeds:
performing a second authentication procedure based on the second authentication information;
if the second authentication procedure fails, implementing the power theft prevention measure; and
if the second authentication procedure succeeds, transferring power to the receiving device.

19. The method of claim 17, wherein the first authentication information includes billing information, and
wherein the second authentication information includes a report of an amount of power received from the test power signal.

20. The method of claim 18, further comprising:
performing foreign object detection; and
adjusting the first and second authentication procedures based on a presence and a location of a foreign object resulting from the foreign object detection.
